(19) United States
(12) Patent Application Publication
(10) Pub. No.: US 2022/0083919 A1
(43) Pub. Date: Mar. 17, 2022

(54) Entity Extraction and Relationship Definition Using Machine Learning

(71) Applicant: SAP SE, Walldorf (DE)

(72) Inventor: Shaswat Deep, Anuppur (IN)

(21) Appl. No.: 17/022,925

(22) Filed: Sep. 16, 2020

(51) Int. Cl. G06N 20/20; G06N 3/04

(52) U.S. Cl. CPC G06N 20/20; G06N 3/0454

(57) ABSTRACT

Data is accessed that encapsulates a corpus of text. Thereafter, at least a portion of the corpus of text is input into an ensemble of machine learning models comprising a convolutional neural network, a long short-term memory network and a graph convolutional network to extract a plurality of features and to define relationships amongst the entities. Data encapsulating the entities and their relationships within the corpus of text are then received from an output layer of the ensemble of machine learning models. Related apparatus, systems, techniques and articles are also described.

### TECHNICAL FIELD

The subject matter described herein relates to machine learning-based techniques for extracting entities and defining relationships amongst extracted entities for consumption by various applications.

### BACKGROUND

Enterprises are continuing to generate enormous amounts of valuable data, in various forms, that could be either structured or unstructured. Text, a typical example of unstructured data, can be utilized for extracting information for various computer-implemented processes. A typical business text could be in a form of an email, text document, or may be in a PDF document. Information extraction from these business documents, has various challenges. Understanding semantics and structure for information extraction from above business document plays an important role in defining, how the business problem should be solved. For instance, you have documents with a fixed pattern or a standard layout across all the documents available, then rule based programming would solve the purpose of information extraction. But, in case of no standardized layout or pattern, then we could approach to solve such problems using machine learning.

Software applications are increasingly consuming non-structured text as part of their various processes. In many cases, such text includes entities which can be used to inform aspects of such processes. Not only do these entities need to be extracted from the corresponding text, relationships amongst such entities also need to be defined. In some cases, custom Named Entity Recognition (NER) models specific to industry or a business can be utilized; however, such NER models are limited in that they are focused on entity extraction alone which makes it difficult to simultaneously characterize the relationship between large number of entities.

### SUMMARY

In a first aspect, data is accessed that encapsulates a corpus of text. Thereafter, at least a portion of the corpus of text is input into an ensemble of machine learning models comprising a convolutional neural network, a long short-term memory network and a graph convolutional network to extract a plurality of features and to define relationships amongst the entities. Data encapsulating the entities and their relationships within the corpus of text are then received from an output layer of the ensemble of machine learning models.

The convolutional neural network can generate character features based on the corpus of text. The convolutional neural network can generate pretrained word embeddings based on the character features. An output of a convolutional layer of the convolutional neural network can be input into the long short-term memory network. The long short-term memory network can identify entities within the corpus of text. An output of the long short-term memory network can be input into the graph convolution network which defines relationships amongst the entities.

Data can be provided that encapsulates the entities and their relationships within the corpus of text. Providing can, for example, include one or more of displaying the entities and their relationship within the corpus of text in a graphical user interface, loading the entities and their relationship within the corpus of text into memory, storing the entities and their relationship within the corpus of text in physical persistence, transmitting the entities and their relationship within the corpus of text to a remote computing system, or consuming the entities and their relationship within the corpus of text by one or more computer-implemented business processes.

In an interrelated aspect, data is accepted that encapsulates a corpus of text. At least a portion of this corpus of text is input into a sequence of machine learning models to extract a plurality of features and to define relationships amongst the entities. Thereafter, data encapsulating entities with the corpus of text and a relationship amongst such entities is received from an output layer of the sequence of machine learning models.

Non-transitory computer program products (i.e., physically embodied computer program products, non-transitory computer readable media, etc.) are also described that store instructions, which when executed by one or more data processors of one or more computing systems, cause at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The subject matter described herein provides many technical advantages. For example, the current subject matter is advantageous in that entity extraction is independent of defining relationships amongst entities. Such an arrangement is beneficial in that errors generated when extracting entities will not propagate to subsequent definitions of relationships. Furthermore, the model architecture provided herein leverages layers of neural networks which allows fine tuning of models weights to perform entity extraction and relationship definition. Still further, the current subject matter can be used to simplify various natural language processing (NLP) tasks including named entity recognition (NER) and defining entity relationships.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a first architecture diagram illustrating a cloud computing system;

FIG. 2 is a second architecture diagram illustrating a cloud computing system;

FIG. 3 is a second architecture diagram illustrating a cloud computing system; and

FIG. 4 is a diagram illustrating aspects of a computing device for implementing the current subject matter.

### DETAILED DESCRIPTION

The current subject matter is directed to machine learning-based techniques for extracting entities from text (including documents) and defining relationships amongst such entities. Such extracted entities and relationships can be consumed or otherwise utilized by various business processes. In some case, the utilized machine learning models are graph convolutional networks (GCNs), a class of neural network.

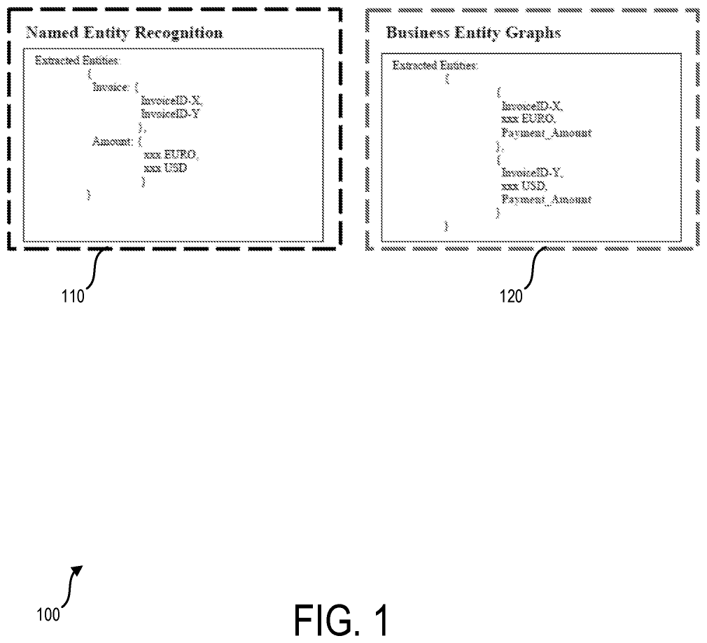

FIG. 1 is a diagram 100 illustrating variability in entity extraction and relationship definition in relation to an e-mail having two invoices numbers with different amounts. Using a first approach 110 for entity extraction and relationship association, the two invoices are extracted as well as the payment amounts for such invoices. However, in the first approach 110, there is no defined relationship between the invoices and the payments. In a second approach 120 generated using the subject matter provided herein, the invoice entities and payment entities are defined as being related as a payment amount. The second approach 120 and the associated entity extraction process with business entity graphs extracts entities with their corresponding relationship which brings more value for various computer-implemented business processes.

An ensemble of models is provided herein for the joint tasks of entity extraction and entity relationship (including for business entities). As individual models for entity extraction and entity relationship have several drawbacks, errors generated during entity extraction will propagate throughout the process. In contrast, by providing taking a joint approach, interactions between/among the models can be leveraged to fine tune model weights by, for example, sharing model parameters.

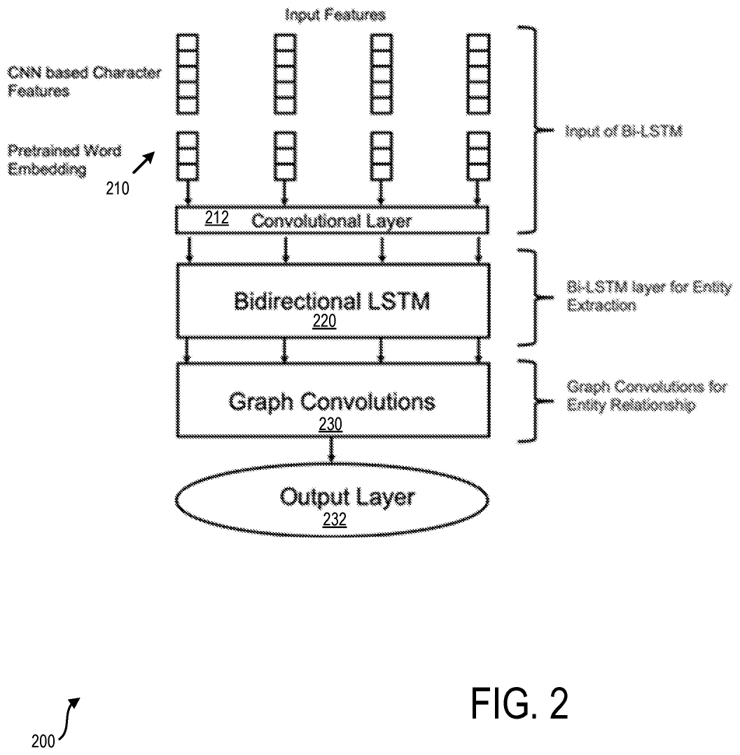

With references to diagram 200 of FIG. 2, the current subject matter uses an ensemble of models in sequence including various classes of neural network including at least one convolution neural network 210 (CNN), at least one recurrent neural network (RNN) based bidirectional long short-term memory network (LSTM) 220 and graph convolutional networks 230 (GCN) with different configurations as follows.

The CNN 210 can be used to encode character information of words from a corpus of text into character level representation. In addition, the CNN 210 can capture local context around characters more efficiently compared to the LSTM 220 via pretrained word embeddings. The CNN 210 includes a convolutional layer 212 which comprises a set of kernels which have a small receptive field, but extend through the full depth of the input volume. During a forward pass through the convolutional layer 212, each kernel is convolved across the width and height of the input volume, computing the dot product between the entries of the filter and the input and producing a 2-dimensional activation map of that filter. As a result, the network learns kernels that activate when it detects some specific type of feature at some spatial position in the input. The output of this convolutional layer 212 is input into the LSTM 220.

The LSTM 220 can be a recurrent neural network (RNN) based bidirectional LSTM. The character level representations and word embeddings (using pre-trained language models) can be fed into the LSTM 220 which will learn the representation of the entities (e.g., business entities) identified by the CNN 210 along with their context (e.g., business context).

The GCNs 230 receives the output of the LSTM 220 for learning business entity relationship and performing classification tasks to understand the relationship type between those entities. The GCN 230 re-encodes the input from the LSTM 220 and performs the task of a classifier and defines/predicts the entity relationship. An output layer of the GCN 232 can provide the entities and their relationships. Provide in this regard, can include, for example, displaying the entities and their relationships, storing the entities and their relationships in physical persistence, loading the entities and their relationships in memory, transmitting the entities and their relationships to a remote computing system and/or to a process. The entities and their relationships can be consumed or otherwise utilized by various computer-implemented processes/services in relation to the corpus of text/associated documents (e.g., triggering a purchase order, generating an invoice, clearing a trading transactions, etc.).

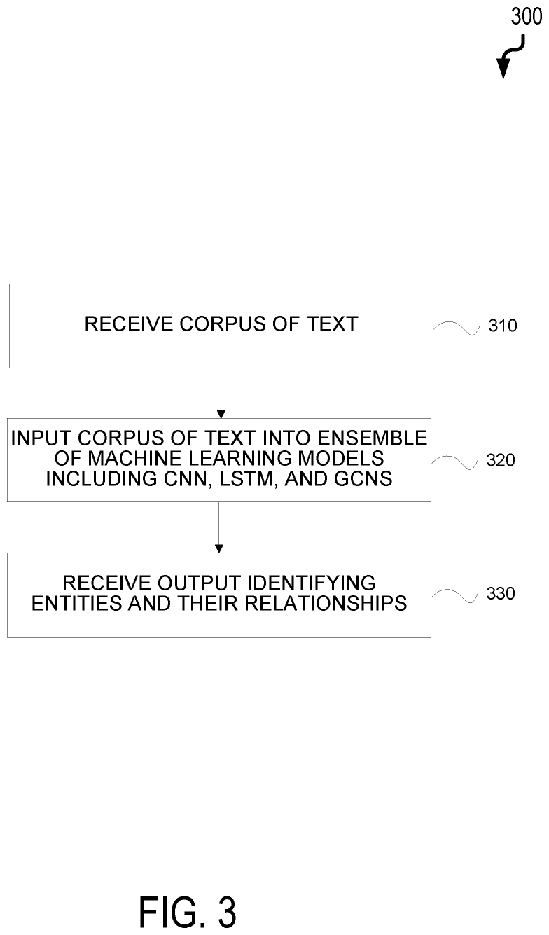

FIG. 3 is a diagram 300 in which, at 310, data is accessed (e.g., received, loaded, etc.) that encapsulates a corpus of text. Thereafter, at least a portion of the corpus of text is input into an ensemble of machine learning models comprising a convolutional neural network, a long short-term memory network and a graph convolutional network to extract a plurality of features and to define relationships amongst the entities. Data is received, at 330, from an output layer of the ensemble of machine learning models that comprises the entities and their relationships within the corpus of text.

To provide further illustration of the current subject matter, below is a sample email text corpus.

### Hi Partner—

Please execute the clearing below.

### ABC

0000

### USA

DocumentNo Ty Reference RCd Doc. Date Net due dt Arre DD DC amount Cur

| DocumentNo | Ty | Reference | RCd Doc. Date | Net due dt | Arre DD | DC amount Cur |
|---|---|---|---|---|---|---|
| 4923423432 | RV | 4933465346 | 19.06.2018 | 04.07.2018 | 2 | 1 . 1 8 6 , 0 2 E U R |
| 4564564566 | DZ | 4933533918 | 05.07.2018 | 05.07.2018 | 1 | 1 . 1 8 6 , 0 2 - E U R |

In the above sample text corpus, certain text is highlighted indicating which an end user would be interested in. The single underlined text represents Document Number, the double underlined text represents Net Due Date and the dashed underlined text represents the Payment amount.

Such data needs to be annotated for training purposes. A sample annotation is provided below.

Plain Text:

| | | |
|---|---|---|
| 4923423432 RV 4930683916 | 19.06.2018 04.07.2018 2 | 2 1 2 , 9 7 E U R |

### Annotation for Training:

{
″text″: ″4923423432 RV 4930683916 19.06.2018 04.07.2018 2 212,97 EUR
″labels″: [

[ [0, 9], Document Number], [ [35, 44], Net Due Date], Payment Date]
[ [0, 9], Document Number], [ [50, 60], Amount], Payment Amount]

]

}

Similar types of annotation can be done through the corpus of text (i.e., the document). Every entity relationship has two attributes: 1) its key entity class and 2) its relationship with the other entity. This data can be passed to the training pipeline along with other natural language processing (NLP) techniques such as embedding and encodings. A pre-trained embedding can be utilized here for word level vectorization. The model architecture can be configured in such a way so that it will not only attempt to learn every entity in the text corpus, it will also characterize each entities relationship with other entities.

Whereas in the inference pipeline, the plain text corpus has to be passed to the trained model, and the trained model can extract entities and their relationships with other entities as follows.

Output from Inference:

```
  {
    Result: [{
      Document Number: “4923423432”
      Net Due Date: “04.07.2018”
      Relationship: “Payment Date”
  },
  {
      Document Number: “4923423432”
      Amount: “212,97 EUR”
      Relationship: “Payment Amount”
  }]
}
```

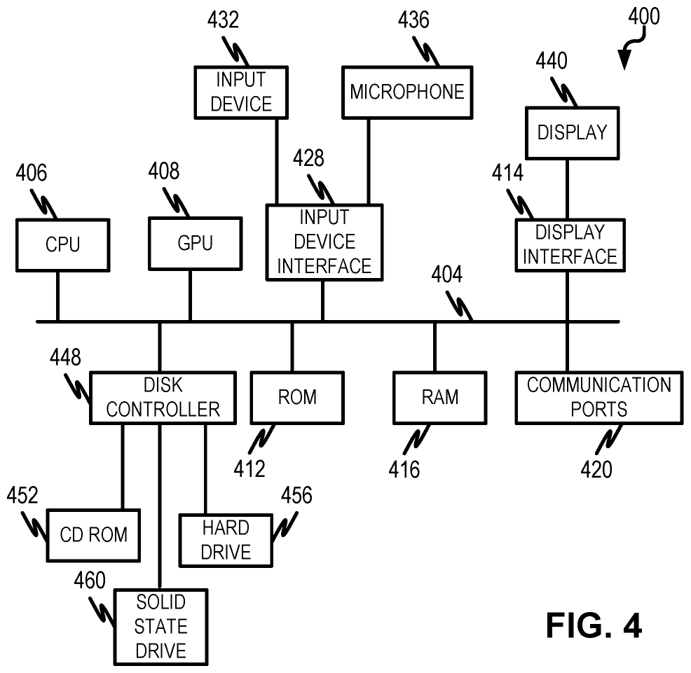

FIG. 4 is a diagram 400 illustrating a sample computing device architecture for implementing various aspects described herein. A bus 404 can serve as the information highway interconnecting the other illustrated components of the hardware. A processing system 406 labeled CPU (central processing unit) (e.g., one or more computer processors/data processors at a given computer or at multiple computers) and/or a processing system 408 labeled GPU (graphical processing unit) can perform calculations and logic operations required to execute a program. A non-transitory processor-readable storage medium, such as read only memory (ROM) 412 and random access memory (RAM) 416, can be in communication with the processing systems 406, 408 and can include one or more programming instructions for the operations specified here. Optionally, program instructions can be stored on a non-transitory computer-readable storage medium such as a magnetic disk, optical disk, recordable memory device, flash memory, or other physical storage medium.

In one example, a disk controller 448 can interface with one or more optional disk drives to the system bus 404. These disk drives can be external or internal solid state drives such as 460, external or internal CD-ROM, CD-R, CD-RW or DVD, or external or internal hard drives 456. As indicated previously, these various disk drives 452, 456, 460 and disk controllers are optional devices. The system bus 404 can also include at least one communication port 420 to allow for communication with external devices either physically connected to the computing system or available externally through a wired or wireless network. In some cases, the at least one communication port 420 includes or otherwise comprises a network interface.

To provide for interaction with a user, the subject matter described herein can be implemented on a computing device having a display device 440 (e.g., a CRT (cathode ray tube) or LCD (liquid crystal display) monitor) for displaying information obtained from the bus 404 via a display interface 414 to the user and an input device 432 such as keyboard and/or a pointing device (e.g., a mouse or a trackball) and/or a touchscreen by which the user can provide input to the computer. Other kinds of input devices 432 can be used to provide for interaction with a user as well; for example, feedback provided to the user can be any form of sensory feedback (e.g., visual feedback, auditory feedback by way of a microphone 436, or tactile feedback); and input from the user can be received in any form, including acoustic, speech, or tactile input. The input device 432 and the microphone 436 can be coupled to and convey information via the bus 404 by way of an input device interface 428. Other computing devices, such as dedicated servers, can omit one or more of the display 440 and display interface 414, the input device 432, the microphone 436, and input device interface 428.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A computer-implemented method comprising:
accessing data encapsulating a corpus of text;
inputting at least a portion of the corpus of text into an ensemble of machine learning models comprising a convolutional neural network, a long short-term memory network and a graph convolutional network to extract a plurality of features and to define relationships amongst the entities; and
receiving, from an output layer of the ensemble of machine learning models, data encapsulating the entities and their relationships within the corpus of text.

2. The method of claim 1, wherein the convolutional neural network generates character features based on the corpus of text.

3. The method of claim 2, wherein the convolutional neural network generated pretrained word embeddings based on the character features.

4. The method of claim 3, wherein an output of a convolutional layer of the convolutional neural network is input into the long short-term memory network.

5. The method of 4, wherein the long short-term memory network identifies entities within the corpus of text.

6. The method of claim 5, wherein an output of the long short-term memory network is input into the graph convolution network, the graph convolutional network defining relationships amongst the entities.

7. The method of claim 1 further comprising:
providing data encapsulating the entities and their relationships within the corpus of text.

8. The method of claim 7, wherein the providing data comprises one or more of: displaying the entities and their relationship within the corpus of text in a graphical user interface, loading the entities and their relationship within the corpus of text into memory, storing the entities and their relationship within the corpus of text in physical persistence, transmitting the entities and their relationship within the corpus of text to a remote computing system, or consuming the entities and their relationship within the corpus of text by one or more computer-implemented business processes.

9. A computer-implemented method comprising:
accessing data encapsulating a corpus of text;
inputting at least a portion of the corpus of text into a sequence of machine learning models to extract a plurality of features and to define relationships amongst the entities; and
receiving, from an output layer of the sequence of machine learning models, data encapsulating entities within the corpus of text and a relationships amongst the entities.

10. The method of claim 9, wherein a first machine learning model in the sequence of machine learning models is a convolutional neural network.

11. The method of claim 10, wherein a second machine learning model in the sequence of machine learning models is a long short-term memory network.

12. The method of claim 11, wherein a third machine learning model in the sequence of machine learning models is a graph convolutional network.

13. The method of claim 12, wherein the convolutional neural network generates character features based on the corpus of text.

14. The method of claim 13, wherein the convolutional neural network generated pretrained word embeddings based on the character features.

15. The method of claim 14, wherein an output of a convolutional layer of the convolutional neural network is input into the long short-term memory network.

16. The method of 15, wherein the long short-term memory network identifies entities within the corpus of text.

17. The method of claim 16, wherein an output of the long short-term memory network is input into the graph convolution network, the graph convolutional network defining relationships amongst the entities.

18. The method of claim 17 further comprising:
providing data encapsulating the entities and their relationships within the corpus of text.

19. The method of claim 18, wherein the providing data comprises one or more of: displaying the entities and their relationship within the corpus of text in a graphical user interface, loading the entities and their relationship within the corpus of text into memory, storing the entities and their relationship within the corpus of text in physical persistence, transmitting the entities and their relationship within the corpus of text to a remote computing system, or consuming the entities and their relationship within the corpus of text by one or more computer-implemented business processes.

20. A system method comprising:
at least one data processor; and
memory storing instructions which, when executed by the at least one data processor, result in operations comprising:
accessing data encapsulating a corpus of text;
inputting at least a portion of the corpus of text into an ensemble of machine learning models comprising a convolutional neural network, a long short-term memory network and a graph convolutional network to extract a plurality of features and to define relationships amongst the entities; and
receiving, from an output layer of the ensemble of machine learning models, data encapsulating the entities and their relationships within the corpus of text.
